(19) United States
(12) Patent Application Publication
(10) Pub. No.: US 2014/0235414 A1
(43) Pub. Date: Aug. 21, 2014

(54) TOOL HOLDING DEVICE OF MACHINE TOOL

(71) Applicant: FANUC Corporation, Yamanashi (JP)

(72) Inventor: Toshifumi MURAMATSU, Yamanashi (JP)

(73) Assignee: FANUC Corporation, Yamanashi (JP)

(21) Appl. No.: 14/174,191

(22) Filed: Feb. 6, 2014

(30) Foreign Application Priority Data
Feb. 20, 2013 (JP) 2013-031399

(51) Int. Cl. B23Q 3/155

(52) U.S. Cl. CPC B23Q 3/15553
USPC 483/59

(57) ABSTRACT

A tool holding device of a machine tool, which holds a tool holder on which a tool is mounted, includes a holding member body and a pair of arm members that are provided on the holding member body. Roller members, which are engaged with a holding groove of the tool holder, are mounted on tips of the arm members. In addition, the holding member body, the pair of arm members, and elastic hinge members that connect the holding member body with the arm members are integrally formed.

### BACKGROUND OF THE INVENTION

1. Field of the Invention

The present invention relates to a tool holding device of a machine tool, and more particularly, to a tool holding device that is used in a machining center.

2. Description of the Related Art

A machining center, which is used as one of machine tools, is generally provided with a tool exchange device that automatically exchanges a tool holder. The tool exchange device generally includes a tool magazine that includes a plurality of grip arms holding the tool holder. The machining center is adapted to select a predetermined tool by an indexing operation of the tool magazine, to move the selected tool to a position immediately below a spindle, and to fit the tool to the spindle by the downward movement of the spindle during the operation of the machining center. For this reason, the grip arms require a structure that satisfies a holding force sufficient for the tool holder and the insertion workability or extraction workability of the tool holder at the same time.

Japanese Patent Application Laid-Open (JP-A) No. 1-289633 discloses an automatic tool exchange device of which a grip arm includes an arm body including protrusions engaged with a tool holder (arbor), a pair of leaf springs fixed to both right and left sides of the arm body by bolts, and press protruding portions formed at tip portions of the leaf springs and is adapted to hold the tool holder by the protrusions of the arm body and the press protruding portions of the leaf springs.

However, in this automatic tool exchange device, a tool holding device holds the tool holder by the press protruding portions of the leaf springs. Accordingly, since the press protruding portions come into slide contact with the tool holder, both the press protruding portions and the tool holder are likely to be worn. For this reason, there is a problem in that the reduction of the life of the grip arm and the deterioration of the reliability of a tool exchange operation of the machine tool are caused.

Further, Japanese Patent Application Laid-Open (JP-A) No. 2005-271179 discloses a tool exchange device of a machine tool of which a grip arm includes a holder receiving portion formed integrally with an arm body, a pair of holding arms rotatably supported by the holder receiving portion, holding rollers provided at one end portions of these holding arms, respectively, and compression coil springs provided at the other end portions of these holding arms and is adapted to bias the holding arms in a direction in which the holding rollers approach each other by the compression coil springs.

However, since this tool exchange device needs to be provided with the compression coil springs as members biasing the holding arms, the number of parts is increased. For this reason, there is a problem in that assembly becomes complicated.

Japanese Patent Application Laid-Open (JP-A) No. 2006-224300 discloses a device which includes a grip arm and a lock element and holds and retains a tool of a machine tool and of which the grip arm includes a holder receiving portion formed integrally with an arm body and an elastically deformable holding arm formed integrally with the holder receiving portion and the lock element can lock the arm body to a clamp position.

However, since the device, which holds and retains a tool of a machine tool, retains a tool holder by tip portions of retainer fingers, the retainer fingers come into slide contact with the tool holder. For this reason, both the holding arm and the tool holder are likely to be worn. In addition, since the device includes the lock element, the number of parts is increased and wear caused by the parts of the lock element occurs. For this reason, there is a problem in that the reduction of the life of the grip arm and the deterioration of the reliability of a tool exchange operation of the machine tool are caused.

### SUMMARY OF THE INVENTION

An object of the invention is to provide a tool holding device of a machine tool of which the number of parts is reduced while wear occurring at each portion of a grip arm is prevented as much as possible.

A tool holding device of a machine tool according to an aspect of the invention holds a tool holder on which a tool is mounted, and includes a holding member body and a pair of arm members that are provided on the holding member body and include roller members mounted on tips thereof and engaged with a holding groove of the tool holder. Further, the holding member body and the pair of arm members are integrally formed with elastically deformable portions interposed therebetween, and the tool holder is held by the holding member body and the arm members.

The elastically deformable portions may be elastic hinge members that are formed integrally with the holding member body and the pair of arm members.

Gaps may be formed between the holding member body and the pair of arm members, and the holding member body and the pair of arm members may be integrally formed with elastic hinge members interposed therebetween.

According to the invention, it is possible to prevent wear occurring at each portion of a tool holding device as much as possible and to reduce the number of parts of a tool holding device.

### BRIEF DESCRIPTION OF THE DRAWINGS

The above and other objects and features of the invention will become apparent by describing the following embodiments in detail with reference to the accompanying drawings in which:

FIG. 1 is a plan view of a grip arm of a tool holding device of a machine tool according to a first embodiment of the invention;

FIG. 2 is a front view of the grip arm illustrated in FIG. 1 that is seen in the direction of an arrow B of FIG. 1; and

FIG. 3 is a plan view of a grip arm of a tool holding device of a machine tool according to a second embodiment of the invention.

### DETAILED DESCRIPTION OF THE PREFERRED EMBODIMENTS

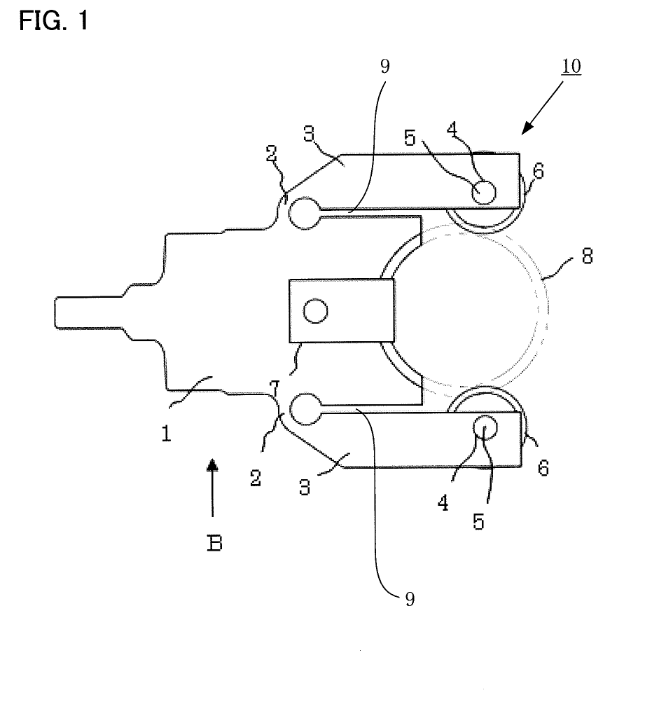

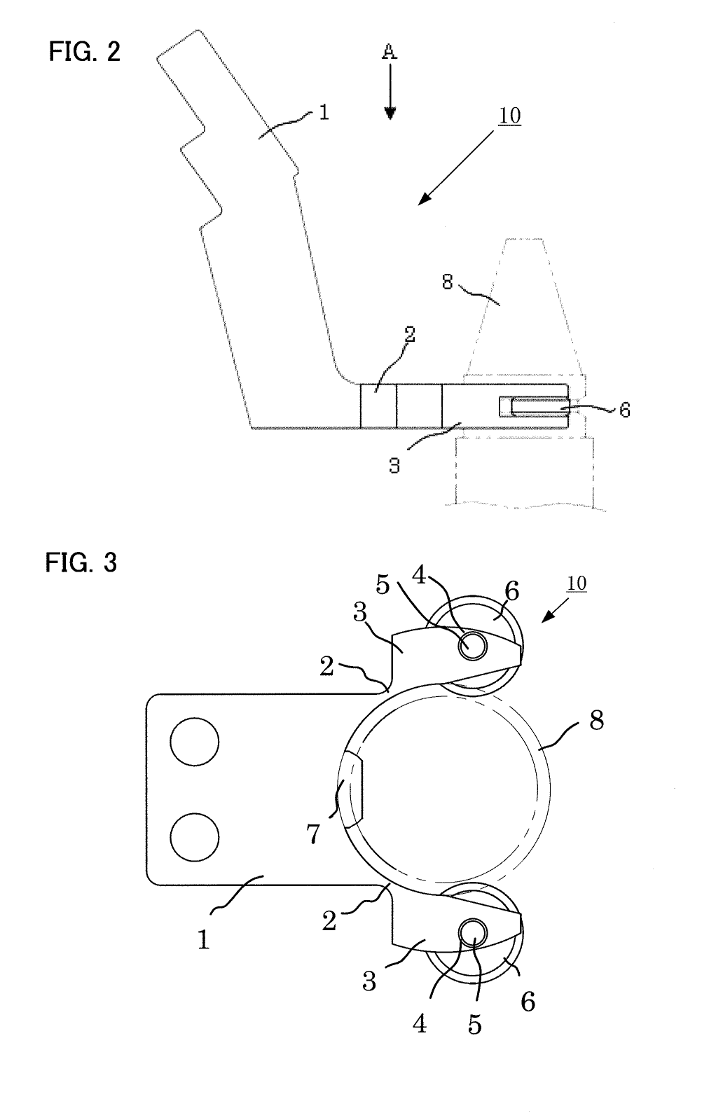

A grip arm of a tool holding device of a machine tool according to a first embodiment of the invention will be described with reference to FIGS. 1 and 2.

A grip arm 10 includes an arm body 1, and holding arms 3 that are provided on both right and left sides of the arm body 1 with elastic hinge members 2 interposed therebetween. Gaps 9 are formed between the arm body 1 and the holding arms 3. Further, a positioning key 7 for positioning a tool holder 8 is provided near the center of the arm body 1. Meanwhile, a holding roller 6 is mounted on the tip portion of each of the holding arms 3. A fixing pin 5 is inserted into a hole portion 4 formed at the tip portion of each holding arm 3 and a shaft hole (not illustrated) formed at the central portion of each holding roller, so that each of these holding rollers 6 is mounted on the holding arm 3.

The holding arm 3 is biased inward by an elastic force of the elastic hinge member 2 provided between the holding arm 3 and the arm body 1. Accordingly, the gap 9 formed between the arm body 1 and the holding arm 3 is a movable range of the holding arm 3.

A grip arm of a tool holding device of a machine tool according to a second embodiment of the invention will be described with reference to FIG. 3.

Elements of a grip arm illustrated in FIG. 3, which have the same functions as the functions of the elements of the grip arm (first embodiment) illustrated in FIG. 1, are denoted by the same reference numerals as the reference numerals that are used in FIG. 1. In the grip arm (second embodiment) illustrated in FIG. 3, the shapes of an arm body 1 and a holding arm 3 are different from the shapes of the arm body 1 and the holding arm 3 of the grip arm (first embodiment) illustrated in FIG. 1 so that the gaps 9 are not formed between the arm body 1 and the holding arms 3. Accordingly, it is possible to make the entire grip arm compact in this embodiment.

In these tool holding devices of a machine tool according to the first and second embodiments, the arm body 1 and the holding arms 3 are integrally formed with the elastic hinge members 2 interposed therebetween. However, as long as being capable of generating an elastic force to hold the tool holder 8 by the holding arms 3 and being formed integrally with the arm body 1 and the holding arms 3, other members can be used instead of the elastic hinge members 2.

1. A tool holding device of a machine tool that holds a tool holder on which a tool is mounted, the tool holding device comprising:
a holding member body; and
a pair of arm members that are provided on the holding member body and include roller members mounted on tips thereof and engaged with a holding groove of the tool holder,
wherein the holding member body and the pair of arm members are integrally formed with elastically deformable portions interposed therebetween, and the tool holder is held by the holding member body and the arm members.

2. The tool holding device of a machine tool according to claim 1,
wherein the elastically deformable portions are elastic hinge members that are formed integrally with the holding member body and the pair of arm members.

3. The tool holding device of a machine tool according to claim 1,
wherein gaps are formed between the holding member body and the pair of arm members, and
the holding member body and the pair of arm members are integrally formed with elastic hinge members interposed therebetween.
